(19) United States
(12) Patent Application Publication
(10) Pub. No.: US 2005/0081139 A1
(43) Pub. Date: Apr. 14, 2005

(54) Clustering based personalized web experience

(76) Inventors: George Witwer, Bluffton, IN (US); Ravikumar Kondadadi, Indianapolis, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/961,314

(22) Filed: Oct. 8, 2004

Related U.S. Application Data
(60) Provisional application No. 60/510,239, filed on Oct. 10, 2003.

(51) Int. Cl. G06F 17/30; G06F 17/00

(52) U.S. Cl. 715/501.1

(57) ABSTRACT

One embodiment of the present invention is a method for the customized presentation of one or more document streams. The method involves accepting or determining criteria characterizing information of interest to a user, and processing a stream of documents, wherein each document is tagged with one or more key content terms, and theme data is generated. The stream is filtered based on whether the criteria apply to each document, the documents in the filtered stream are clustered, and the clustered documents (including the theme data) are presented to the user via a visual user interface.

### CROSS-REFERENCE TO RELATED APPLICATIONS

The benefit of U.S. Provisional Patent Application No. 60/510,239 (filed 10 Oct. 2003) is claimed, and that provisional application is hereby incorporated by reference.

### FIELD OF THE INVENTION

The present invention relates to systems and methods for customizing the presentation of electronic documents. More specifically, the present invention relates to a clustering- and filtering-based method for selecting and organizing one or more streams of documents for presentation to a user.

### BACKGROUND

With the explosive growth in the volume of information available to users via the Internet, users have begun to develop a need for tools that assist in selecting and configuring relevant information for display. In some cases, users have focused interests that happen to match the focus of particular sources that collect news relating to that interest. For example, a fan of a major league baseball team is likely to find a great deal of relevant information and news about the team on the team's website.

Not all interests are so easily matched, however, and individuals with those interests typically have to sift through a great deal of irrelevant information to find nuggets of interest. One who enjoys hiking a particular stretch of a long trail (such as the Appalachian Trail) might find a mailing list or website focused on the whole trail, then have to search for articles about his or her particular favorite area (the last fifty miles at the north end, for example). In other cases, the user might not even be consciously aware of preferences, or perhaps be unable to articulate them in a boolean query. In these cases also, users are left with inefficient tools for finding and viewing relevant information.

There is thus a need for further contributions and improvements to information collection and presentation technology.

### SUMMARY

It is an object of the present invention to provide an improved system and method for finding and displaying information likely to be of interest to a user. It is another object of the present invention to enable users to access relevant information in a conveniently organized format, using either explicit or implicit preference criteria.

These objects and others are achieved by various forms of the present invention. One form of the present invention is a system and method wherein a personal profile is formed for a user from the output of a clustering algorithm as applied to (1) the content of electronic documents viewed by the user, and (2) data directly entered by the user, click stream data characterizing a series of hypertext navigation actions by the user, or purchase data identifying one or more items that have been purchased by the user. Content is presented to the user as a function of selected data in the personal profile.

In another form of the present invention, the user provides one or more criteria characterizing information of interest to him or her. A stream of documents is processed, wherein each document is tagged with one or more key content terms, and theme data is generated. The stream is then filtered based on whether the criteria apply to each document, then the documents in the filtered stream are clustered. The clustered documents (including the theme data) are presented to the user via a visual user interface.

Yet another form of the present invention is a method involving accessing electronic documents, attaching key content-based terms to each of the electronic documents, creating a personal profile for a user, and filtering the documents as a function of the personal profile and the key terms. The method further involves applying a soft clustering algorithm to the filtered electronic documents to cluster the documents into content-based categories and presenting the categories to the user.

In still another form of the present invention, a first clustering algorithm is applied to electronic data accessed by a user to form a user profile, and the electronic documents are filtered as a function of the user profile to retain a set of electronic documents of interest to the user. Additionally, a second clustering algorithm is applied to the set of electronic documents of interest to the user in order to produce clusters that can then facilitate access to the documents by the user.

### BRIEF DESCRIPTION OF THE DRAWINGS

FIG. 1 is a block diagram of the system according to one embodiment of the present invention.

FIG. 2 is a block diagram showing data flow in a first example embodiment of the present invention.

FIG. 3 is a block diagram of data flow according to another example embodiment of the present invention.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, one form of the present invention is a method for the customized presentation of one or more document streams. The method involves accepting criteria characterizing information of interest to a user, processing a stream of documents, wherein each document is tagged with one or more key content terms, and theme data is generated for the document. The method further involves filtering the stream based on whether the criteria apply to each document, clustering the filtered stream, and presenting the clustered documents (including the theme data) to the user via a visual user interface.

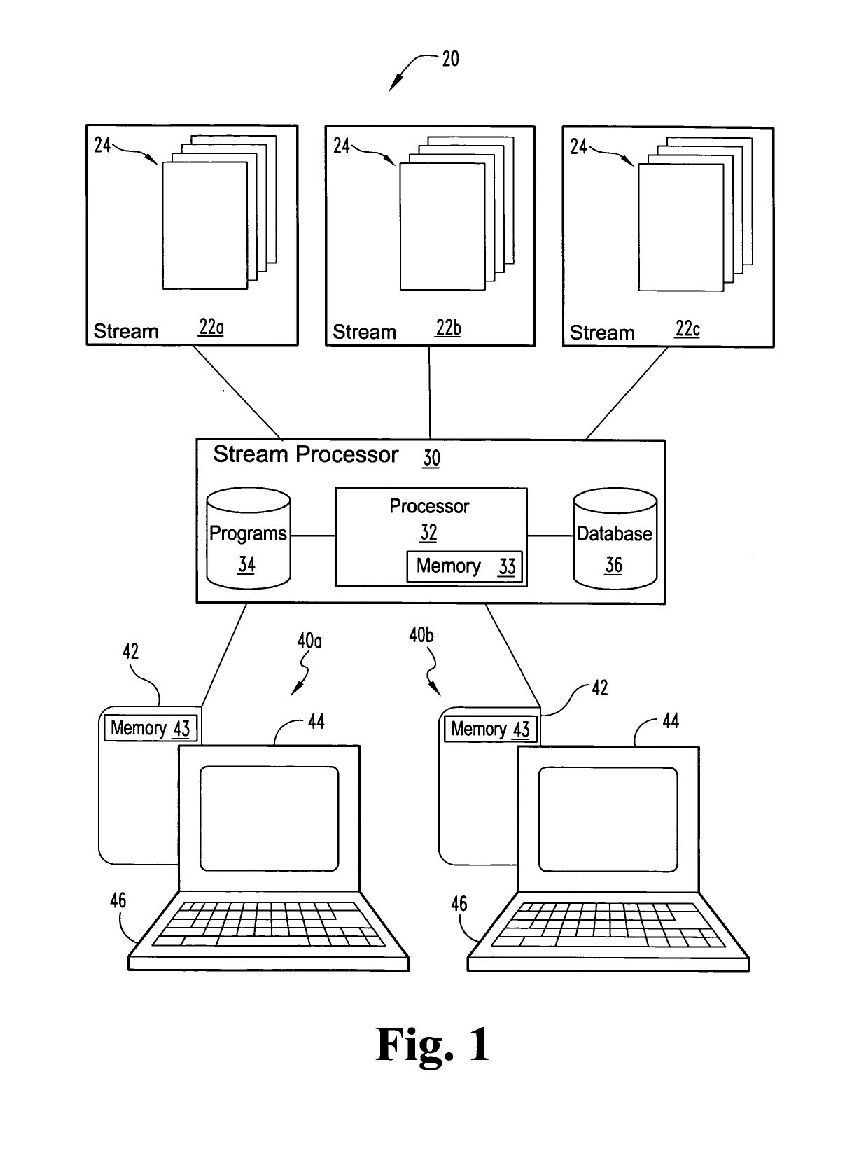

FIG. 1 illustrates a system 20 according to one embodiment of the present invention. System 20 generally includes streams 22 of electronic documents 24, a stream processor 30, and client computers 40, such as computers 40a and 40b. As examples, streams 22 include streams 22a, 22b, and 22c. Stream processor 30 generally includes a processor 32 with memory 33, programs 34, and a database 36. In a preferred embodiment, stream processor 30 operates in conjunction with a remote server operably connected to the Internet. Client computers 40 generally include processors 42 with memory 43, output display devices 44, and input devices 46. Generally referring to FIG. 1, the operation of system 20 involves processing the streams 22 with the stream processor 30 and presenting the processed streams to the client computers 40.

System 20 is designed to present articles or documents in an organized, content-based arrangement to users of the client computers 40. As illustrated, output display device 44 is a standard monitor device. It should also be appreciated that the output display device 44 can be of a Cathode Ray Tube (CRT) type, Liquid Crystal Display (LCD) type, plasma type, Organic Light Emitting Diode (OLED) type, or such different type as would occur to those skilled in the art. Alternatively or additionally, one or more other output devices can be utilized, such as a printer, one or more loudspeakers, headphones, or such different type as would occur to those skilled in the art. Input devices 46 include an alphanumeric keyboard and mouse or other pointing device of a standard variety. Alternatively or additionally, one or more other input devices can be utilized, such as a voice input subsystem or a different type as would occur to those skilled in the art. Client computers 40 also include one or more communication interfaces suitable for connection to a computer network, such as a Local Area Network (LAN), Municipal Area Network (MAN), and/or Wide Area Network (WAN) like the Internet. Processor 42 is designed to process signals and data associated with system 20 and generally includes circuitry, memory 43, and/or other standard operational components as is known in the art.

Additionally, stream processor 30 includes the processor 32 for processing signals and data associated with system 20. Processor 32 also generally includes circuitry, memory 33, and/or other standard operational components as is known in the art. In a preferred embodiment, programs 34 include software agents designed to monitor interactions of the client computers 40 with local electronic documents, remote servers, and/or remote websites. Alternatively or additionally, software agents can be located on the client computers 40 to monitor transactions with remote servers. Further, database 36 stores data related to the operation of system 20, including, as examples, article streams, tagged articles, filtered articles, personal profile criteria, and clustered documents.

Processor 32 and processor 42 can be of a programmable type; a dedicated, hardwired state machine; or a combination of these. Processor 32 and processor 42 perform in accordance with operating logic that can be defined by software programming instructions, firmware, dedicated hardware, a combination of these, or in a different manner as would occur to those skilled in the art. For a programmable form of processor 32 or processor 42 at least a portion of this operating logic can be defined by instructions stored in memory. Programming of processor 32 and/or processor 42 can be of a standard, static type; an adaptive type provided by neural networking, expert-assisted learning, fuzzy logic, or the like; or a combination of these.

As illustrated, memory 33 and memory 43 are integrated with processor 32 and processor 42, respectively. Alternatively, memory 33 and memory 43 can be separate from or at least partially included in one or more of processor 32 and processor 42. Memory 33 and memory 43 can be of a solid-state variety, electromagnetic variety, optical variety, or a combination of these forms. Furthermore, the memory 33 and the memory 43 can be volatile, nonvolatile, or a mixture of these types. The memory 33 and the memory 43 can include a floppy disc, cartridge, or tape form of removable electromagnetic recording media; an optical disc, such as a CD or DVD type; an electrically reprogrammable solid-state type of nonvolatile memory, and/or such different variety as would occur to those skilled in the art. In still other embodiments, such devices are absent.

Processor 32 and processor 42 can each be comprised of one or more components of any type suitable to operate as described herein. For a multiple processing unit form of processor 32 and/or processor 42, distributed, pipelined, and/or parallel processing can be utilized as appropriate. In one embodiment, processor 32 and processor 42 are provided in the form of one or more general purpose central processing units that interface with other components over a standard bus connection; and memory 33 and memory 43 include dedicated memory circuitry integrated within processor 32 and processor 42, and one or more external memory components including a removable disk. Processor 32 and processor 42 can include one or more signal filters, limiters, oscillators, format converters (such as DACs or ADCs), power supplies, or other signal operators or conditioners as appropriate to operate system 20 in the manner described in greater detail.

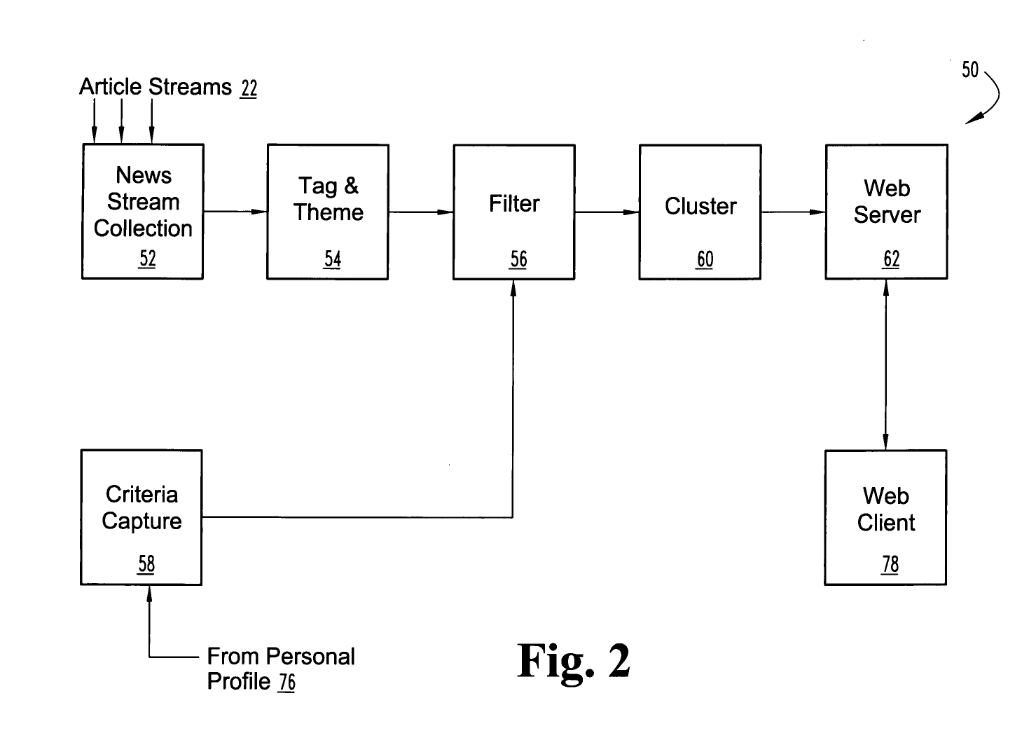

FIG. 2 illustrates a server-side data flow procedure 50 in a first example embodiment of the present invention. Procedure 50 is described in stages, as depicted in FIG. 2. In a preferred embodiment, the procedure 50 is performed by the stream processor 30 at a remote computer, in other words, a computer other than a local computer operating in conjunction with the client computers 40. In stage 52, article streams 22 are processed to collect various news streams within the article streams 22. In one embodiment, the news streams are a set of news articles from a variety of sources, including Internet news services. However, it should be appreciated that the collected articles in article streams 22 can consist of other types of electronic documents as would occur to one skilled in the art. Thereafter, the articles in the news streams are tagged with key content terms and theme data (hereinafter “tag data”) in stage 54.

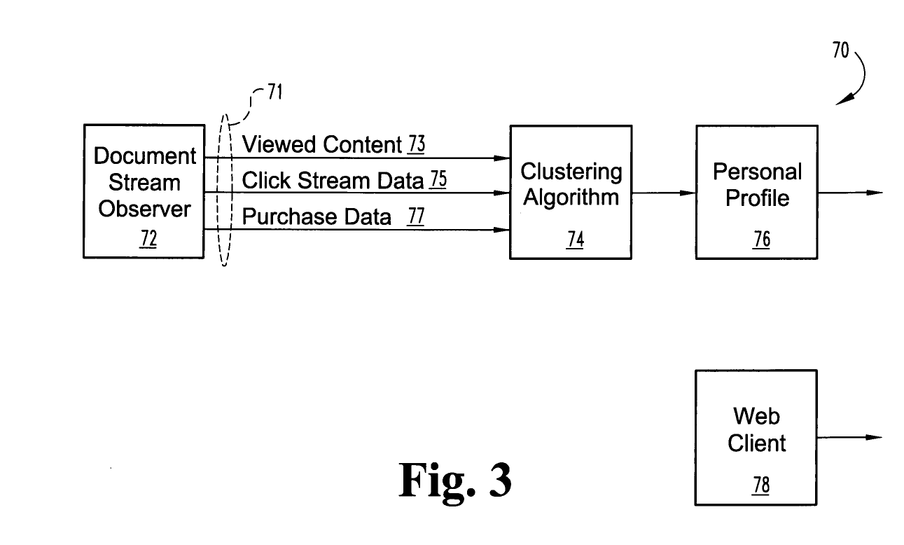

From stage 54, procedure 50 continues with stage 56 where the articles in the news stream are filtered as a function of the criteria developed in stage 58 (as will be explained in connection with FIG. 3) and the tag data, thereby producing matching filtered articles. In other words, the articles are filtered based on whether the criteria apply to the tag data of the articles. The filtered articles are clustered in stage 60. The documents in clusters are preferably grouped generally by subject matter. In a preferred embodiment, stage 60 involves the application of a soft clustering algorithm to the filtered news stream. A soft clustering algorithm is an algorithm (such as the one described in greater detail below) in which an object is placed in more than one cluster when appropriate. From stage 60, procedure 50 continues with stage 62 where the clustered articles are forwarded to an Internet web server, so that the clustered articles, along with theme data, can thereafter be forwarded to a web client in stage 78. In a preferred embodiment, the clusters are generally content-based categories of news articles.

FIG. 3 illustrates a client-side data flow procedure 70 according to this example embodiment of the present invention. Procedure 70 is described in stages, as depicted in FIG. 3. In a preferred embodiment, the procedure 70 is performed by software running on the client computers 40 operating in conjunction with the web client software (browser) 78. Regarding the data flow procedure 70, data streams 71 are processed by a document stream observer in stage 72. Data streams 71 are Internet navigation actions, documents, and other interactions by a user, and generally include content 73 of electronic documents that have been viewed by the user, click stream data 75, and purchase data 77. However, it should be appreciated that other types of Internet usage patterns by a user can be used in connection with the present invention. Preferably, data streams 71 include contacts and interactions with both remote servers and local resources. To process data streams 71, the document stream observer is preferably a software agent installed on a user's computer, such as the client computer 40a, to monitor and observe data streams 71.

From stage 72, procedure 70 continues with stage 74 where a clustering algorithm is applied to the data streams 71. In stage 76, the results of the clustering algorithm are utilized to generate a personal profile, which is processed to yield filtering criteria that are captured in stage 58 (see FIG. 2). The criteria are then used to select the filtered documents that meet the criteria in stage 56. After the filtered documents are clustered in stage 60, the web server presents the clusters to the web client in stage 78 in a convenient, organized, and content-based format. Additionally, in one embodiment, the clusters presented provide for a grouped presentation of news articles on a personalized Internet web page or similar electronic document, tailoring the Internet web page to the user's individual needs and preferences as observed in data streams 71.

It should be appreciated that the stages explained in connection with the client-side data flow procedure 50 and the server-side data flow procedure 70 in FIGS. 2 and 3 can be performed at different locations, such as different computers, as would occur to one skilled in the art. Additionally or alternatively, the stages described in connection with procedure 50 and procedure 70 can all be performed at one computer or location.

In a preferred embodiment, the methods, procedures, and operations described in connection with data flow procedure 50 and data flow procedure 70 each occur two or more times. Data flow 50 and data flow 70 can be performed at times requested by a user or at pre-determined times or intervals. In one embodiment, the user's personal profile is updated daily, and derived criteria are uploaded to server 30. When the user requests a display of electronic documents, the user's criteria (from the personal profile) are used to select appropriate electronic documents using the tag data of the documents. In another embodiment, the software agent periodically observes electronic documents and/or data streams visited and/or generated by a user and updates the personal profile 76. Additionally, article streams 22 are periodically collected, tagged and themed, and thereafter filtered as a function of the updated personal profile 76 to generate an updated set of filtered articles 56. The updated filtered articles 56 are clustered (stage 60) and presented to the user.

Additionally or alternatively to FIG. 3, the personal profile 76 can be developed or supplemented by asking the user a set of questions regarding the user's preferences, receiving answers to those questions, and processing the feedback received from the user. In one embodiment, the answers to the set of questions contain information to supplement the content and criteria of the personal profile 76. In another embodiment, the answers to the set of questions contain sufficient information and are thus used to create the personal profile 76.

An alternative form of the present invention includes clustering multiple users based on the personal profiles generated for those users. In a preferred embodiment, a soft clustering algorithm is applied to the personal profiles to generate clusters of users who share similar interests. The soft clustering algorithm allows for placement of one particular user into one or more clusters based on the content of the user's personal profile. Electronic documents including Internet web pages, electronic articles, and/or items purchased or evaluated, among other things, can be recommended to one or more users based on the Internet navigation actions of other users in the same cluster. As an additional example, electronic documents viewed or accessed by users in a first cluster can be suggested to a user in a second cluster if the user in the second cluster is conducting Internet usage activities typical of the personal profiles of users in the first cluster, and so on.

Another alternative form of the present invention involves a variation of the procedures described above. A personal profile is created for a user in accordance with the procedures described in relation to FIG. 3. Thereafter, a software agent or similar program searches the Internet for electronic documents related to subjects found in the user's personal profile. The electronic documents from the search results that include similar concepts and themes are clustered through application of a soft clustering algorithm. The clusters are suggested to the user for viewing or accessing. These procedures are performed periodically to update the personal profile and the clusters presented as a function of further data streams generated by the particular user and available articles in streams 22.

In various other alternative embodiments, the division of tasks in data flows 50 and 70 are split in various ways among multiple computing devices. For example, in one embodiment, each stage in data flow 50 is performed by a different computing device. In another embodiment, one computing device performs collection (52), tagging, and theming (54), while a second performs filtering (56) and clustering (60), and a third performs web server functions (62). In yet another embodiment, the tasks in stages 52, 54, 56, 58, 60, and 62 are distributed among the computing devices in a server farm (a computing cluster), as will be understood and achievable by one of ordinary skill in this technology.

One known clustering method that is used in some embodiments of the present invention is known as the “Fuzzy ART” (adaptive resonance theory) method. Assume that a collection of items, each characterized by a vector, is to be grouped into one or more clusters. Select a choice parameter β>0, vigilance parameter ρ (where 0≦ρ≦1), and learning rate λ (where 0≦λ≦1). Then for each input vector I, and set of candidate prototype vectors P, (step 1) find the closest prototype vector PᵢεP that maximizes

$$\frac{‖ \vec{I} ⋀ {\vec{P}}_{i} ‖}{β + ‖ {\vec{P}}_{i} ‖} .$$

Parameter β, therefore, works as a tiebreaker when multiple prototype vectors are subsets of the input pattern I.

The selected prototype Pᵢ then undergoes a “vigilance test” (step 2) that evaluates the similarity between the winning prototype and the current input pattern against the selected vigilance parameter ρ by determining

$$\frac{‖ \vec{I} ⋀ {\vec{P}}_{i} ‖}{‖ \vec{I} ‖} ≻ ρ .$$

If prototype Pᵢ passes the vigilance test, it is adapted to the input pattern I according to step (3), described in the next paragraph. If prototype Pᵢ does not pass the vigilance test, the current prototype is deactivated for the current input pattern I and other prototypes in P undergo the vigilance test until one of the prototypes passes. If no prototype Pᵢ in P passes, a new prototype is created and added to P for the current input pattern I.

If one of the prototypes Pᵢ passes the vigilance test, then the matched prototype is updated (step 3) to move closer to the current input pattern according to \vec{P}ᵢ=λ(\vec{I}\hat{ }\vec{P}ᵢ)+(1−λ)\vec{P}ᵢ. As can be observed, selected parameter λ controls the relative weighting between the old prototype value and the input pattern in the revision of the prototype vector. If λ=1, the algorithm is characterized as “fast learning.”

A preferred “soft clustering” variant on Fuzzy ART methods has been developed to improve user profile development and output document clustering in embodiments of the present invention. This variant operates on a collection of documents in three stages: pre-processing, cluster building, and keyword selection.

In the pre-processing stage, stop words are removed from all of the documents in the collection, and a list of the w (remaining) unique words in the collection of documents is created. A document vector is then formed for each document of the frequencies with which each word from the word list appears in that document.

The cluster building stage adapts the Fuzzy ART algorithm to make it a soft clustering algorithm. In particular, instead of selecting a “closest prototype” in step 1, each prototype PᵢεP is considered according to the vigilance test in step 2, and a fuzzy “degree of membership” of I in Pᵢ is assigned based on

$$\frac{‖ \vec{I} ⋀ {\vec{P}}_{i} ‖}{‖ \vec{I} ‖} .$$

Each prototype Pᵢ that passes the vigilance test is then updated as in step 3 above.

It is noted that in various embodiments of this modified approach computational intensity is substantially reduced by avoiding the iterative search for a “best match” in step 1 of Fuzzy ART as described above. In fact, in many embodiments the system can be scaled to cluster more and more documents using only O(n) computational power, providing tremendous advantages (and even enabling otherwise intractable undertakings) versus O(n log n) and higher-order methods known in the art. Further, by removing that choice step from the clustering method, the system ceases to depend on one of the user-selected input parameters (choice parameter β). This streamlines system design by reducing the number of variables over which the designer must optimize parameter selections.

In the keyword selection stage of the modified approach, the words in each cluster are ranked based, for example, on the number of documents in the cluster in which the word appears, and on the similarity of those documents as defined by the vigilance test. The top several words (7-10 in preferred embodiments) are selected to be displayed as representative of the documents in the cluster.

All publications, prior applications, and other documents cited herein are hereby incorporated by reference in their entirety as if each had been individually incorporated by reference and fully set forth.

While the invention has been illustrated and described in detail in the drawings and foregoing description, the same is to be considered as illustrative and not restrictive in character it being understood that only the preferred embodiment has been shown and described and that all changes and modifications that come within the spirit of the invention are desired to be protected.

1. A personalization method, comprising:
forming a personal profile for a user from the output of a first clustering algorithm applied to (1) a plurality of documents viewed by the user, and (2) one or more data streams comprising at least one of:
data entered by the user;
click stream data characterizing a series of web navigation actions by the user; and
purchase data identifying one or more items that have been purchased by the user; and
presenting content to the user as a function of selected data in the personal profile.

2. The method of claim 1, further comprising:
providing a software agent on a user's computer; and
capturing data from the plurality of documents and the one or more data streams with the software agent.

3. The method of claim 2, wherein the one or more data streams are collected from communications between the user's computer and one or more remote computers.

4. The method of claim 1, wherein the forming is performed by the user's computer.

5. The method of claim 1, further comprising applying the first clustering algorithm at two or more times to update the personal profile.

6. The method of claim 1, wherein the forming comprises:
asking the user a set of questions,
receiving answers to the set of questions, and
applying the first clustering algorithm to the answers.

7. The method of claim 1, wherein the plurality of documents are electronic articles.

8. The method of claim 1, further comprising filtering electronic documents as a function of selected data in the personal profile.

9. The method of claim 8, wherein the presenting operates on the filtered electronic documents.

10. The method of claim 8, wherein the filtering occurs responsively to a request for electronic documents by the user.

11. The method of claim 8, wherein the filtering comprises searching the Internet for electronic documents as a function of selected data in the personal profile.

12. The method of claim 8, further comprising applying a second clustering algorithm to the filtered electronic documents to produce one or more document clusters.

13. The method of claim 12, wherein the first clustering algorithm and the second clustering algorithm are soft clustering algorithms.

14. The method of claim 12, wherein the content presented is the one or more clusters.

15. A method for the customized presentation of one or more document streams, comprising:
accepting one or more user-provided criteria;
processing a stream of documents, the processing for each document in the stream including:
tagging the document with one or more key content terms; and
generating theme data for the document;
filtering the stream based on whether the criteria apply to the key content terms for each document;
clustering the filtered stream; and
presenting the clustered stream, including theme data for at least one presented document, to a user via a graphical user interface.

16. The method of claim 15, wherein the accepting and the presenting occur at a first computer and the processing, the filtering and the clustering occur at a second computer.

17. The method of claim 15, wherein the accepting, the presenting, and the processing occur at a first computer and the filtering and the clustering occur at a second computer.

18. The method of claim 15, wherein the documents are electronic articles.

19. The method of claim 15, wherein accepting the user-provided criteria includes:
asking the user a set of questions;
receiving answers to the set of questions; and
applying a soft clustering algorithm to the user's answers.

20. The method of claim 15, wherein the clustering includes applying a soft clustering algorithm.

21. The method of claim 20, wherein each document is clustered into one or more document clusters.

22. The method of claim 15, further comprising developing the user-provided criteria, wherein the developing includes applying a clustering algorithm to (1) a plurality of electronic documents viewed by the user, and (2) one or more data streams comprising at least one of:
data entered by the user;
click stream data characterizing a series of web navigation actions by the user; and
purchase data identifying one or more items that have been purchased by the user.

23. The method of claim 22, wherein the developing occurs at a user's computer.

24. The method of claim 22, wherein the clustering algorithm is a soft clustering algorithm.

25. The method of claim 22, further comprising:
providing a software agent on a user's computer; and
collecting the plurality of electronic documents and the one or more data streams with the software agent.

26. The method of claim 25, wherein the one or more data streams are collected from communications between the user's computer and one or more remote computers.

27. A method, comprising:
accessing a plurality of electronic documents;
attaching one or more key terms to each of the electronic documents to represent its content;
creating a personal profile for a user;
filtering the electronic documents as a function of the personal profile and the key terms;
applying a first soft clustering algorithm to the filtered electronic documents to cluster the filtered electronic documents into two or more content-based categories; and
presenting the two or more content-based categories to the user.

28. The method of claim 27 wherein the two or more content-based categories contain substantially the same quantity of the electronic documents.

29. The method of claim 27, further comprising:
updating the personal profile two or more times; and
performing the accessing, the attaching, the filtering, the applying, and the presenting, two or more times.

30. The method of claim 27, wherein the creating includes applying a second clustering algorithm to electronic data accessed by the user.

31. The method of claim 30, wherein the second clustering algorithm is a soft clustering algorithm.

32. A clustering method, comprising:
applying a first clustering algorithm to electronic data accessed by a user to form a user profile;
filtering electronic documents as a function of the user profile to retain a set of user-appropriate appropriate electronic documents; and
applying a second clustering algorithm to the set of user-appropriate electronic documents to produce one or more clusters.

33. The method of claim 32, further comprising accessing the one or more clusters.

34. The method of claim 32, wherein the first clustering algorithm and the second clustering algorithm are soft clustering algorithms.

35. The method of claim 32, wherein the first clustering algorithm and the second clustering algorithm are the same clustering algorithm.

36. A system, comprising:
a client computer, wherein the client computer accesses electronic documents and clusters data from the electronic documents to develop user criteria; and
a remote computer, wherein the remote computer accepts the user criteria, processes a stream of documents, filters the stream of documents based on whether the user criteria apply to each document in the stream; clusters the filtered stream, and presents the clustered stream to the client computer.

37. A system, comprising a processor and a computer-readable medium encoded with programming instructions executable by the processor to:
access electronic documents;
tag each electronic document with one or more key content terms;
generate theme data for each electronic document;
filter the electronic documents based on whether preference criteria of a user apply to the key content terms of each electronic document;
apply a first clustering algorithm to the electronic documents to produce clusters; and present the clusters, including theme data, to the user.

38. The system of claim 37, wherein the programming instructions are further executable by the processor to apply a second clustering algorithm to electronic data accessed by the user to create the preference criteria.

39. The system of claim 38, wherein the first clustering algorithm and the second clustering algorithm are the same soft clustering algorithm.

40. A method, comprising:
a user at a computer accessing a plurality of electronic documents;
the user at the computer generating one or more data streams comprising at least one of:
data entered by the user;
click stream data characterizing a series of web navigation actions by the user; and
purchase data identifying one or more items that have been purchased by the user; and;
the computer capturing data from the plurality of electronic documents and the one or more data streams with a software agent on the computer; and
the computer displaying clusters of electronic articles, wherein the clusters are generated by applying a first clustering algorithm to filtered electronic articles, wherein the filtered electronic articles are generated by attaching tag data to electronic articles and filtering the electronic articles as a function of the tag data and a set of user criteria.

41. The method of claim 40, further comprising the computer developing the set of user criteria by applying a second clustering algorithm to the captured data.

42. The method of claim 41, wherein the first clustering algorithm and the second clustering algorithm are soft clustering algorithms.

43. The method of claim 40, wherein the computer attaches the tag data to the electronic documents.

44. The method of claim 40, wherein the computer filters the electronic documents.

45. The method of claim 40, wherein the computer applies the first clustering algorithm.

46. An apparatus, comprising one or more processors and a memory encoded with programming instructions executable by the one or more processors to:
accept one or more user-provided criteria;
process a stream of documents, wherein to process each document in the stream includes:
tagging the document with one or more key content terms; and
generating theme data for the document;
filter the stream based on whether the criteria apply to each document;
cluster the filtered stream; and
present the clustered stream, including the theme data, to the user via a graphical user interface.

47. The apparatus of claim 46, further comprising one or more parts of a computer network carrying one or more signals encoding the programming instructions.

48. The apparatus of claim 46, the programming instructions being further executable by the processor to develop the user-provided criteria, wherein to develop includes:
asking the user a set of questions;
receiving answers to the set of questions; and
applying a soft clustering algorithm to the user's answers.

49. The apparatus of claim 46, the programming instructions being further executable by the processor to develop the user-provided criteria, wherein to develop includes applying a clustering algorithm to
a plurality of electronic documents viewed by the user, and
one or more data streams comprising at least one of:
data entered by the user;
click stream data characterizing a series of Web navigation actions by the user; and
purchase data identifying one or more items that have been purchased by the user.

50. A method of clustering a collection of documents, comprising:
creating an ordered list of w unique words in the collection of electronic documents;
initializing a set P of zero or more prototype vectors, each of a dimension w; and
for each document d in the collection of electronic documents:
a) generating a w-dimensional vector I_{d} of numbers that each characterize the frequency in d of the word in the corresponding position in the ordered list;
b) for each prototype Pᵢ:
i) determining a degree of membership of document d in Pᵢ; and
ii) if the degree of membership is greater than a predetermined threshold ρ, updating prototype Pᵢ as a function of document d.

51. The method of claim 50, further comprising, after the processing for each document d is complete, selecting a plurality of key words representative of each prototype Pᵢ.

52. The method of claim 50, wherein the updating assigns \vec{P}ᵢ=λ(\vec{I}_{d}\hat{ }\vec{P}ᵢ)+(1−λ)\vec{P}ᵢ for a predetermined λ, where 0≦λ≦1.

53. The method of claim 50, wherein the determining step for each document I_{d} and prototype Pᵢ comprises calculating ∥\vec{I}_{d}\hat{ }\vec{P}ᵢ∥.

54. The method of claim 50, wherein:
determining the degree of membership of I_{d} in Pᵢ comprises calculating ∥\vec{I}_{d}\hat{ }\vec{P}ᵢ∥/∥\vec{I}_{d}∥.
